(19) United States
(12) Patent Application Publication
(10) Pub. No.: US 2016/0222805 A1
(43) Pub. Date: Aug. 4, 2016

(54) TURBINE BLADE AND GAS TURBINE

(71) Applicant: Siemens Aktiengesellschaft, Munich (DE)

(72) Inventor: Peter Schroder, Essen (DE)

(73) Assignee: Siemens Aktiengesellschaft, Munich (DE)

(21) Appl. No.: 15/026,006

(22) PCT Filed: Sep. 4, 2014
(86) PCT No.: PCT/EP2014/068800

§ 371 Date: Mar. 30, 2016

(30) Foreign Application Priority Data
Oct. 10, 2013 (EP) 13187991.8

(51) Int. Cl. F01D 5/30; F01D 5/32

(52) U.S. Cl. CPC F01D 5/3015; F01D 5/326; F05D 2220/32; F05D 2240/30

(57) ABSTRACT

A turbine blade with a turbine blade airfoil and a turbine blade base for securing the turbine blade in a turbine shaft groove of a turbine shaft, wherein the turbine blade base includes a retaining device that retains securing device that secures a flat covering element arranged at the top of the turbine blade base. The retaining device is arranged on the outside of the turbine blade base.

### CROSS REFERENCE TO RELATED APPLICATIONS

This application is the US National Stage of International Application No. PCT/EP2014/068800 filed Sep. 4, 2014, and claims the benefit thereof. The International Application claims the benefit of European Application No. EP13187991 filed Oct. 10, 2013. All of the applications are incorporated by reference herein in their entirety.

### FIELD OF INVENTION

The invention relates to a turbine blade having a turbine blade airfoil and having a turbine blade root for securing the turbine blade in a turbine shaft slot of a turbine shaft, in which case the turbine blade root comprises a retaining device for retaining securing means for securing a flat covering element arranged on the head side of the turbine blade root.

The invention also relates to a gas turbine having a multiplicity of turbine blades and having a turbine shaft to which the turbine blades are attached in each case by means of a turbine blade root.

### BACKGROUND OF INVENTION

Generic turbine blades are well known from the prior art. The respective turbine blade has a turbine blade root by means of which it is immobilized in a corresponding turbine shaft slot formed on a turbine shaft. To that end, the respective turbine blade with its turbine blade root is pushed, in the axial insertion direction which is aligned with the axis of rotation of the turbine shaft, into the corresponding turbine shaft slot and is immobilized. On the insertion side of the turbine shafts, the turbine blade roots and the turbine shaft slots are clad with sealing plates.

In order in particular to secure the circumferential position of the sealing plates, the sealing plates on one hand are inserted into a circumferential slot of the turbine shaft and on the other hand are arranged in a secured manner by means of securing means on the turbine blade roots.

The securing means comprise at least a bolt element and a securing plate element. For the purpose of retaining the securing means, there are provided, on the turbine blade roots, regions of removed material in the form of pockets which are inserted into the turbine blade roots. These pockets are introduced into the turbine blade roots for example by erosion, as is known in particular from WO 2010/094539 A1.

Moreover, U.S. Pat. No. 4,480,958 A discloses a turbine blade having a rotor airfoil, a turbine blade root and a turbine blade platform arranged between the turbine blade root and the rotor airfoil, wherein the turbine blade is mounted on a turbine disk of a turbine. In that context, a circumferential slot, into which a first end of a retaining plate attached to the turbine disk can engage, is machined into the turbine blade platform. In that context, the circumferential slot is cut into the turbine blade platform, which has a negative effect on the force flow within the turbine blade. The retaining plate has, in essence, two functional sections, namely first a seal section for sealing cooling ducts which are located between the turbine disk and the turbine blade root, and second a retaining section by means of which the turbine blade can be held in position in a turbine blade receiving slot, wherein the retaining plate is secured via the seal section by means of a screw screwed into the turbine disk. This screw secures the retaining plate; the screw being screwed into an internal thread configured as a retaining device. A retaining device arranged on the turbine blade root for retaining additional securing means is not shown there.

Furthermore, DE 199 60 896 A1 teaches a retaining device for rotor blades, mounted in blade root receiving portions, of an axial turbomachine with a retaining ring, which on one hand engages radially inward in a catch formed on a rotor disk and on the other hand has radially outward projecting sections, each of which can engage in a retaining groove, which is open radially inward and is machined into the blade root, in order to prevent, by means of the retaining ring, the rotor blade from moving axially out of the blade root receiving portion of the rotor disk.

The retaining groove is also cut into the blade root, which has a negative effect on the force flow within the turbine blade.

In addition, U.S. Pat. No. 5,137,430 A discloses an arrangement consisting of a rotor disk and a multiplicity of rotor blades arranged thereon, the rotor blades each having a rotor blade airfoil, a rotor blade root and a rotor blade platform arranged between the rotor blade root and the rotor blade airfoil. A receiving groove, which is open radially inward, is machined in the rotor blade root for receiving a retaining ring, by means of which the rotor blade is prevented from moving axially out of a rotor blade root receiving portion of the rotor disk. In that context, the receiving groove is cut into the rotor blade root, which has a negative effect on the force flow within the turbine blade.

### SUMMARY OF INVENTION

The invention has the object of further developing generic turbine blades such that forces acting on the turbine blade can be better taken up and transmitted by the turbine blade and in particular by a turbine blade root of the turbine blade.

The object of the invention is achieved with a turbine blade having a turbine blade airfoil and having a turbine blade root for securing the turbine blade in a turbine shaft slot of a turbine shaft, in which case the turbine blade root comprises a retaining device for retaining securing means for securing a flat covering element arranged at the head side of the turbine blade root, wherein the retaining device is arranged outside the turbine blade root on this turbine blade root.

The fact that the retaining device retaining the securing means is arranged outside the turbine blade root on this turbine blade root significantly improves the properties of taking up and transmitting forces specifically through the turbine blade root.

The circumlocution “outside the turbine blade root on this turbine blade root” expresses, in the context of the invention, that the retaining device is not machined into the material body of the turbine blade root, for example by milling, eroding or the like.

Rather, the retaining device is produced by an accumulation of material on the outside of this material body or of the turbine blade root.

The concept of “head side” describes, in the context of the invention, the head side of the turbine blade root, which is at the same time also the short side of this turbine blade root. The head side accordingly runs transversely or perpendicular to the direction of insertion of the turbine blade root into a turbine shaft slot receiving the turbine blade root, the direction of insertion being aligned with the direction of the axis of rotation of the turbine shaft. In this context, the head side is advantageously flat. This head side extends for example at right angles to an undulating outer side of a turbine blade root in the form of a fir tree.

The term “covering element” describes, in the context of the invention, any element by means of which it is possible to extensively cover both the turbine shaft in the region of its turbine shaft slots and also at least partially the turbine blade roots at the fluid inlet side of the turbine blade and/or at the fluid outlet side of the turbine blade at the turbine shaft. In particular, such a covering element comprises a sealing plate for generating a lateral seal in the region of the turbine blade roots.

The securing means can take a great number of forms. In any case, they are different from the flat covering element. This means that the securing means can be immobilized on the retaining device, irrotationally in the circumferential direction of the turbine shaft, independently of the covering element.

In particular, the securing means can be inserted through the flat covering element in order to be retained in the retaining device provided for that purpose.

For example, the securing means comprise one or advantageously at least two securing elements that can be inserted through an opening in the flat covering element.

Generic securing means are well known from the prior art and can in principle be used here. They comprise at least a bolt element and a securing plate element, which are at least partially immobilized on the retaining device.

Thus, in the context of the invention, the present retaining device is a securing means retaining device. This retaining device is therefore not used for inserting the flat covering element.

For that reason, the retaining device provided on the turbine blade root is also arranged at a distance from a circumferential slot which is arranged on the turbine blade or on the turbine blade root and into which the covering element can be inserted.

Thus, the invention is characterized in particular by a retaining device which is arranged at a distance from a circumferential slot for inserting one end of a covering plate and by means of which the present securing means can be immobilized on the turbine blade root, irrotationally in the circumferential direction of the turbine shaft.

The retaining device is arranged on the turbine blade root, below a turbine blade platform which is arranged between the turbine blade airfoil and the turbine blade root. That means that the retaining device is located on a side of the turbine blade platform that is oriented away from the turbine blade airfoil, namely on that side on which the turbine blade root is located.

In that respect, a particularly advantageous embodiment variant also provides that the retaining device comprises a receiving space formed outside the turbine blade root for arranging a bolt element of the securing means.

If this receiving space is arranged outside the turbine blade root, it is possible to dispense with a pocket, used hitherto and disadvantageously positioned in the force flow, which extends into the turbine blade root. This makes it possible to positively raise the load-bearing capacity of the turbine blade, at least in the region of the turbine blade root, or the turbine blade root can be made smaller while keeping its load-bearing capacity constant.

That means that the retaining device is arranged outside, on the outer side of the turbine blade root, and thus projects out from the head-side surface.

If the retaining device is arranged above the surface of the turbine blade root, proceeding from the outer side of the turbine blade root, it is advantageously possible for the installation space for coolant lines or the like, available within the turbine blade root, to be enlarged substantially.

Moreover, the securing means and thus also the covering element can be installed particularly quickly and simply if the retaining device comprises a receiving space for arranging a bolt element of the securing means, the receiving space being accessible from more than one side, advantageously from three sides.

In the present case, the receiving space is arranged outside, on the outer side of the turbine blade root. That means that the receiving space is arranged outside the material body of the turbine blade root, and as a result no material is removed from the turbine blade root, thus resulting in no weakening of the material of this material body forming the turbine blade root. It is thus possible to significantly improve the force flow within the turbine blade root.

In this context, the receiving space is accessible at least from the head side of the turbine blade root in the direction of insertion of the turbine blade.

The receiving space can be configured particularly simply in terms of construction if the retaining device comprises two retaining lug elements which are spaced apart from one another and which at least partially surround a receiving space for arranging a bolt element of the securing means.

It will be understood that it is also possible for more than two such retaining lug elements to be provided to create the retaining device. However, this would increase the complexity of production accordingly.

A receiving space for this purpose is simple to produce on the turbine blade root if the two retaining lug elements are arranged such that they run parallel to one another.

The securing means can be very well immobilized and mounted with respect to acceleration forces acting in the circumferential direction of the turbine shaft if the two retaining lug elements are arranged on the turbine blade root such that they extend in the longitudinal direction of the turbine blade airfoil. In this context, the two retaining lug elements are arranged next to one another as seen in the circumferential direction of the turbine shaft.

In addition, it is advantageous if the two retaining lug elements are arranged on the head side of the turbine blade root such that they are perpendicular to the circumferential surface of the turbine shaft. It is thus possible for the covering element to be advantageously supported on the present retaining device.

The covering element can be secured to the turbine blade in a very operationally secure manner by means of the securing elements if the two retaining lug elements are arranged radially above the circumferential surface of the turbine shaft.

A substantially improved support for the covering element on the turbine blade root can be achieved if the two retaining lug elements have a length which is greater than their height and/or thickness. Such a length makes it possible, additionally, to formulate a longitudinal bearing surface for the covering element on the retaining device.

The retaining device can easily be reworked, in particular mechanically, if the two retaining lug elements are arranged on the short side of the turbine blade root.

If the two retaining lug elements are arranged on the insertion side of the turbine shaft slots arranged in the turbine shaft, the retaining device arranged outside the turbine blade root can easily be integrated into an arrangement of a multiplicity of turbine blades and a turbine shaft.

Retention of the securing means on the retaining device can be further simplified if the two retaining lug elements are beveled on the longitudinal side edges of their mutually facing lug sides. In particular, a bevel on that longitudinal edge which is oriented away from the surface of the turbine blade root can advantageously simplify installation of the securing means.

It will be understood that the two retaining lug elements can be produced, in terms of production processes, in different ways on the turbine blade root. For example, they can be milled or cast from solid together with the turbine blade root. Alternatively, they are secured in a material-bonded manner to the turbine blade root as separate components.

In that regard, it is advantageous if the two retaining lug elements are milled, cast, welded or adhesively bonded on the turbine blade root. Producing the retaining lug elements is, in addition, often more cost-effective than for example eroding corresponding pockets within the turbine blade root.

The turbine blade root is in particular in the shape of a fir tree.

The object of the invention is also achieved with a gas turbine having a multiplicity of turbine blades and a turbine shaft to which the turbine blades are attached in each case by means of a turbine blade root, wherein the gas turbine comprises turbine blades in accordance with one of the features described here.

The use of the present turbine blade allows a gas turbine to be advantageously further developed.

By means of the present turbine blade, the sealing element can additionally be immobilized on a gas turbine in a particularly low-vibration manner since it can in addition be supported on the two retaining lug elements if it is secured by the securing means.

The present retaining device can be used on turbine blades of any gas turbine type.

### BRIEF DESCRIPTION OF THE DRAWINGS

An embodiment of the turbine blade according to the invention is explained below with reference to the appended schematic drawings. In the drawings:

FIG. 1 shows, schematically, a perspective view of a turbine blade according to the invention, in the region of the turbine blade root with a retaining device, arranged outside the turbine blade root, for retaining a bolt element for immobilizing a flat covering element,

FIG. 2 shows, schematically, a detail view of the retaining device from FIG. 1 arranged on the turbine blade root, and

FIG. 3 shows, schematically, a side view of turbine blades arranged on a turbine shaft, as illustrated by way of example in FIGS. 1 and 2.

### DETAILED DESCRIPTION OF INVENTION

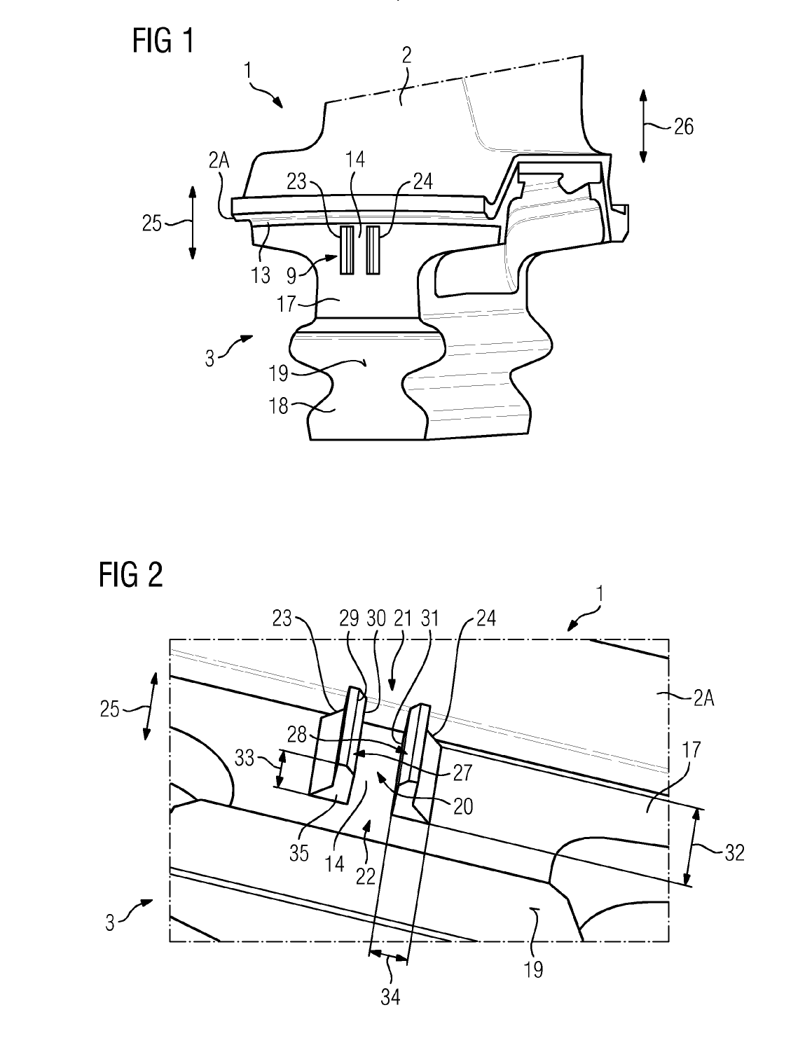

The turbine blade 1 shown in FIGS. 1 and 2 has a turbine blade airfoil 2, only part of which is shown here, and a turbine blade root 3. The turbine blade 1 is further characterized by a turbine blade platform 2A which is arranged between the turbine blade airfoil 2 and the turbine blade root 3, such that the turbine blade root 3 is separated from the turbine blade airfoil 2 by the turbine blade platform 2A.

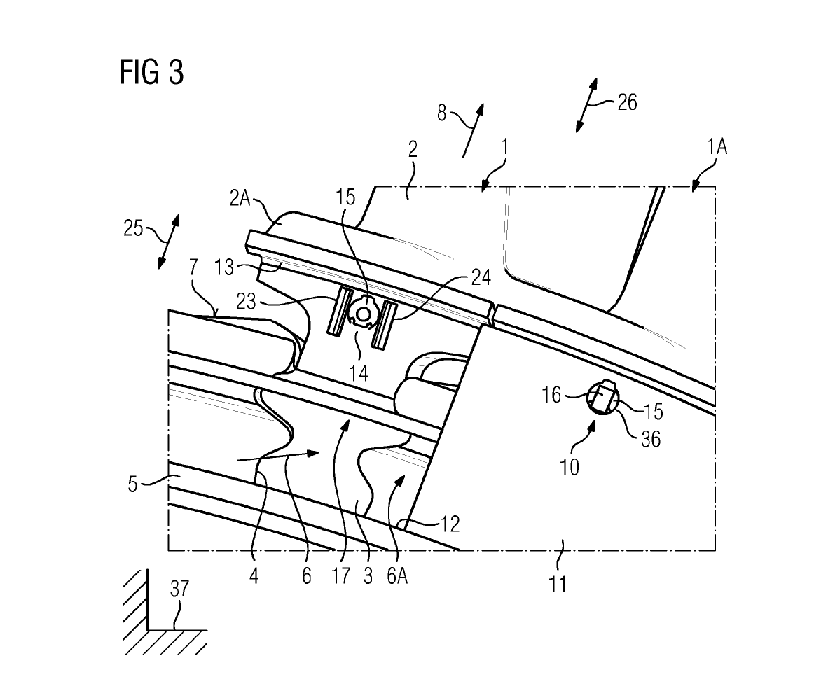

As is clear from the illustration in FIG. 3, the turbine blade 1 is immobilized, by means of the turbine blade root 3, in a turbine shaft slot 4 of a turbine shaft 5 that can be made to rotate about an axis of rotation (not shown here).

To that end, the turbine blade root 3 is pushed, in the axial insertion direction 6 which is aligned with the axis of rotation of the turbine shaft 5, into the turbine shaft slot 4 on the insertion side 6A of the turbine shaft 5.

Thus, a multiplicity of turbine blades 1, 1A etc. are attached to the turbine shaft 5 over the circumferential surface 7 of the turbine shaft 5.

In this exemplary embodiment, the turbine blade root 3 is in the form of a fir tree. Accordingly, the turbine shaft slot 4 is of complementary configuration. The fir tree shape secures the turbine blade 1 to the turbine shaft 5 in the radial direction 8 in a manner which is known.

Furthermore, the turbine blade 1 comprises, on its turbine blade root 3, a retaining device 9 for retaining securing means 10 (see FIG. 3) for securing a flat covering element 11 which is arranged on the turbine blade root 3 and the underside of which is inserted into a fixing slot 12 running around the circumferential side of the turbine shaft 5 and the upper side of which is inserted into a lateral slot 13 formed by the turbine blades 1, 1A.

In this context, the flat covering element 11 represents a seal plate, which is known per se, for sealing the end face of the arrangement consisting of the multiplicity of turbine blades 1 and 1A etc. and the turbine shaft 5 in the region of the respective turbine blade root 3 (numbered only by way of example).

According to the invention, the retaining device 9 is arranged on the turbine blade root 3 outside the turbine blade root 3, such that the latter can be designed more solidly, since it is possible to dispense with a removal of material in the form of a pocket on the turbine blade root 3. The retaining device 9 is arranged at a distance from the turbine blade platform. Furthermore, the retaining device 9 is arranged at a distance from both the fixing slot 12 and the lateral slot 13, and is thus formed differently therefrom.

Nonetheless, the retaining device 9 has a receiving space 14 for arranging a bolt element 15 and at least one more securing plate element 16 of the securing means 10, the receiving space 14 being arranged on or in front of the head side 17 of the turbine blade root 3.

In this context, the retaining device 9 is placed on the head side 17, which simultaneously represents the short side (numbering not repeated here) of the turbine blade root 3, such that it is arranged above the surface 19 of the turbine blade root 3 proceeding from the outer side 18 of the turbine blade root 3.

If the retaining device 9 comprises a receiving space 14, formed outside the turbine blade root 3, for arranging at least the bolt element 15, it is then possible to entirely dispense with a pocket hitherto machined into the turbine blade root 3.

In addition, the receiving space 14 is arranged not very deep on the arrangement and is accordingly easily accessible.

Furthermore, the retaining device 9 is such that the receiving space 14 for arranging the securing means 10 is accessible from three sides 20, 21 and 22, such that it is simple to prepare in terms of construction, wherein the side 20 corresponds to the insertion side 6A.

The constructive complexity is further reduced since the receiving space 14 of the retaining device 9 is defined simply by two retaining lug elements 23 and 24 which are spaced apart from one another and, in this exemplary embodiment, are milled from solid together with the turbine blade root 3.

These two retaining lug elements 23 and 24 are arranged parallel to one another and their longitudinal extent 25 (here indicated only by way of example) is aligned in the longitudinal direction 26 of the turbine blade airfoil 2.

The two retaining lug elements 23 and 24 are arranged perpendicular to the circumferential surface 7 of the turbine shaft 5 and also radially, that is to say as seen in the radial direction 8, above this circumferential surface 7 on the head side 17 of the turbine blade root 3, thus further improving the accessibility of the receiving space 14.

Since the retaining lug elements 23 and 24 are actually entirely covered by the flat covering element 11 when the securing means 10 are installed, it is advantageous that the retaining lug elements 23 and 24 each have a bevel 29 (numbered only by way of example) on their respective longitudinal side edge 27 and 28 oriented away from the surface 19 of the turbine blade root 3. These beveled longitudinal side edges 27 and 28 are located on the mutually facing lug sides 30 and 31 of the retaining lug elements 23 and 24.

Each of the two retaining lug elements 23 and 24 has a length 32 which is greater than the height 33 of the respective retaining lug element 23 or 24. Equally, the length 32 is greater than the thickness 34 of the respective retaining lug element 23 or 24.

The two mutually facing lug sides 30 and 31 are planar below the respective bevel 29, such that the receiving space 14 accordingly has planar delimiting internal wall surfaces which can support the securing means 10.

Furthermore, the two retaining lug elements 23 and 24 each have a broader plinth region 35 (numbered only by way of example) in order to provide the retaining lug elements 23 and 24 with good stability.

Specifically according to the illustration of FIG. 3, a flat covering element 11 is arranged in front of the turbine blade root 3 of the other turbine blade 1A, wherein once this flat covering element 11 has been placed, first the bolt element 15 is inserted through an opening 36 in the flat covering element 11 and is inserted into the receiving space 14. In addition, so as to prevent it being lost, the bolt element 15 is clamped within the receiving space 14 by means of the securing plate element 16, which is also inserted through the opening 36 in the flat covering element 11 and is inserted into the receiving space 14.

Thus, the flat covering element 11 is arranged quickly and simply in front of the respective turbine blade 1 on the turbine shaft 5 of a gas turbine 37.

Although the invention has been described and illustrated in more detail by way of the preferred exemplary embodiment, the invention is not restricted by this disclosed exemplary embodiment and other variations can be derived herefrom by a person skilled in the art without departing from the scope of protection of the invention.

1.-15. (canceled)

16. A turbine blade comprising:
a turbine blade airfoil and having a turbine blade root for securing the turbine blade in a turbine shaft slot of a turbine shaft, wherein the turbine blade root comprises a retaining device for retaining securing means for securing a flat covering element arranged on the head side of the turbine blade root,
wherein the retaining device is arranged outside the turbine blade root on this turbine blade root, and
wherein the retaining device comprises a receiving space formed outside the turbine blade root for arranging a bolt element of the securing means.

17. The turbine blade as claimed in claim 16,
wherein the retaining device is arranged, proceeding from the outside of the turbine blade root, above the surface of the turbine blade root.

18. The turbine blade as claimed in claim 16,
wherein the retaining device comprises a receiving space for arranging a bolt element of the securing means,
wherein the receiving space is accessible from more than one side, preferably from three sides.

19. The turbine blade as claimed in claim 16,
wherein the retaining device comprises two retaining lug elements which are spaced apart from one another and which at least partially surround a receiving space for arranging a bolt element of the securing means.

20. The turbine blade as claimed in claim 19,
wherein the two retaining lug elements are arranged such that they run parallel to one another.

21. The turbine blade as claimed in claim 19,
wherein the two retaining lug elements are arranged on the turbine blade root such that they extend in the longitudinal direction of the turbine blade airfoil.

22. The turbine blade as claimed in claim 19,
wherein the two retaining lug elements are arranged on the head side of the turbine blade root such that they are perpendicular to the circumferential surface of the turbine shaft.

23. The turbine blade as claimed in claim 19,
wherein the two retaining lug elements are arranged radially above the circumferential surface of the turbine shaft.

24. The turbine blade as claimed in claim 19,
wherein the two retaining lug elements are arranged on the short side of the turbine blade root.

25. The turbine blade as claimed in claim 19,
wherein the two retaining lug elements are arranged on the insertion side of the turbine shaft slots arranged in the turbine shaft.

26. The turbine blade as claimed in claim 19,
wherein the two retaining lug elements are beveled on the longitudinal side edges of their mutually facing lug sides.

27. The turbine blade as claimed in claim 19,
wherein the two retaining lug elements have a length which is greater than their height and/or thickness.

28. The turbine blade as claimed in claim 19,
wherein the two retaining lug elements are milled, cast, welded or adhesively bonded on the turbine blade root.

29. A gas turbine comprising:
a multiplicity of turbine blades and having a turbine shaft to which the turbine blades are attached in each case by means of a turbine blade root,
wherein the gas turbine comprises turbine blades as claimed in claim 16.
